(19) United States
(12) Patent Application Publication
(10) Pub. No.: US 2026/0112537 A1
(43) Pub. Date: Apr. 23, 2026

(54) VIBRATION REDUCTION UNIT AND TRANSFORMER COMPRISING SAME

(71) Applicant: LS ELECTRIC CO., LTD., Anyang-si, Gyeonggi-do (KR)

(72) Inventor: Seong Eon KIM, Anyang-si, Gyeonggi-do (KR)

(21) Appl. No.: 19/120,507

(22) PCT Filed: Jul. 20, 2023
(86) PCT No.: PCT/KR2023/010492

§ 371 Date: Apr. 11, 2025

(30) Foreign Application Priority Data
Dec. 1, 2022 (KR) 10-2022-0165591

(51) Int. Cl. H01F 27/33; G10K 11/172; G10K 11/24; H01F 27/12

(52) U.S. Cl. CPC H01F 27/33; G10K 11/172; G10K 11/24; H01F 27/12; G10K 2210/125; G10K 2210/3214; G10K 2210/3224; G10K 2210/3227

(57) ABSTRACT

A vibration reduction unit and a transformer comprising same are disclosed. A vibration reduction unit according to one aspect of the present invention comprises: a rod part connected to the outside and extending in one direction; and a mass part coupled to the rod part so as to reduce vibration transmitted to the rod part, wherein the mass part may comprise: a mass member formed to have a predetermined mass; and a mass hollow formed to penetrate the inside of the mass member and to which the rod part is coupled.

### CROSS-REFERENCE TO RELATED APPLICATIONS

The present application is a National Stage of International Application No. PCT/KR2023/010492, filed on Jul. 20, 2023, which claims priority to Korean Application No. 10-2022-0165591, filed on Dec. 1, 2022, the entire contents of each hereby incorporated by reference.

### FIELD

The present disclosure relates to a vibration reduction unit and a transformer including the same, and more particularly, to a vibration reduction unit capable of reducing vibration or noise generated during operation and emitted to the outside, and a transformer including the same.

### BACKGROUND

A transformer is a general term for an apparatus that converts the value of AC voltage or AC current using electromagnetic induction. A transformer includes a coil that is energized with the outside and receives an alternating current, and an iron core around which the coil is wound. A plurality of coils are provided, each wound around the iron core.

When an alternating current is applied to one of the coils, a magnetic flux is formed in the iron core. As the magnetic flux changes, a current induced through electromagnetic induction is applied to the other coil. The induced current has a current or voltage different from the applied AC current and may be transmitted to an external load.

The iron core provided in the transformer is formed by stacking a plurality of iron plates or the like. As the transformer operates, magnetostriction occurs in the iron core. Vibration, noise, or the like may occur in the iron core due to the magnetostriction. The generated vibration and noise are transmitted to the outside, which may adversely affect the environment in which the transformer is disposed.

Specifically, the generated vibration may be transmitted to other components of the transformer and other devices connected to the transformer. Accordingly, there is a concern that the coupling state between the components of the transformer and the coupling state of the transformer and other devices may become unstable.

Accordingly, technologies for reducing vibration or noise generated when a transformer operates have been introduced.

Korean Patent Registration No. 10-1530347 discloses a suspension device for a transformer in a substation. Specifically, it discloses a suspension device for a transformer in a substation wherein the suspension device supports a substation transformer and absorbs vibrations caused by the transformer's own vibration and external influences transmitted to the transformer, thereby blocking the resulting vibrations.

However, the suspension device disclosed in the above prior art document can only support a transformer of a preset size and weight. That is, if the transformer's weight or size changes, the suspension device must be redesigned to accommodate the increased weight or size. That is, the suspension device disclosed in the above prior art document can only support a transformer of a preset size and weight, and it is difficult to support a transformer of a different size and weight.

In addition, the suspension device disclosed in the above prior art document is formed to support the transformer from the lower side. Therefore, the height of the transformer and suspension device increases, which limits their acceptance in existing substations.

Korean Patent Registration No. 10-1661138 discloses an apparatus for reducing vibration of transformers in a substation. Specifically, it discloses an apparatus for reducing vibration for absorbing vibration of a transformer by stacking buffer blocks inside a box partially buried in the ground and coupling a transformer to the buffer blocks.

However, the apparatus for reducing vibration of transformers disclosed in the above-mentioned prior art document is assumed to be buried underground. Therefore, if the transformer is placed away from the ground, it is difficult to apply the apparatus for reducing vibration according to the above-mentioned prior art document.

In addition, the apparatus for reducing vibration disclosed in the above prior art document is also configured to support the transformer from the lower side. Therefore, the vibration generated by the operation of the transformer can be absorbed from the lower side, but it is difficult to reduce the vibration emitted in other directions.
Korean Patent Registration No. 10-1530347 (2015.06.29.)
Korean Patent Registration No. 10-1661138 (2016.10.10.)

### SUMMARY

The present disclosure aims to solve the above problems, and the present disclosure is directed to providing a vibration reduction unit having a structure capable of reducing vibration or noise generated during operation and a transformer including the same.

The present disclosure is also directed to providing a vibration reduction unit having a structure capable of reducing vibration or noise of a member where vibration or noise is concentrated during operation, and a transformer including the same.

The present disclosure is also directed to providing a vibration reduction unit having a structure capable of simply reducing vibration or noise caused thereby, and a transformer including the same.

The present disclosure is also directed to providing a vibration reduction unit provided in various structures and capable of simply reducing vibration or noise caused thereby, and a transformer including the same.

The present disclosure is also directed to providing a vibration reduction unit having a structure capable of design change in various forms and a transformer including the same.

The present disclosure is also directed to providing a vibration reduction unit having a structure capable of reducing various vibrations or noise caused thereby, and a transformer including the same.

The problems of the present disclosure are not limited to those mentioned above, and other problems not mentioned will be clearly understood by those of ordinary skill in the art from the following description.

According to an aspect of the present disclosure, provided is a vibration reduction unit, including a rod part connected to the outside and extending in one direction; and a mass part coupled to the rod part so as to reduce vibration transmitted to the rod part, wherein the mass part includes a mass member formed to have a predetermined mass; and a mass hollow formed to penetrate the inside of the mass member and to which the rod part is coupled.

In this case, a vibration reduction unit may be provided in which the mass part includes a first mass member positioned to be biased to one side; and a second mass member positioned adjacent to the first mass member and positioned to be biased to the other side, and the rod part includes a first rod penetrating a first mass hollow of the first mass member; and a second rod penetrating a second mass hollow of the second mass member, coupled to and communicating with the first rod.

In addition, a vibration reduction unit may be provided in which the mass member extends radially with respect to the coupled rod and is formed in a plate shape having a thickness in the one direction.

In addition, according to another aspect of the present disclosure, provided is a transformer, including a housing with a space formed therein: a power transmission unit accommodated in the space of the housing and energizably connected to an external power source and load: a noise-generating unit coupled to the exterior of the housing, receiving vibration generated by the power transmission unit, and extending in one direction by a length longer than the diameter of its cross-section; and a vibration reduction unit coupled to the noise-generating unit and configured to reduce the transmitted vibration, wherein the vibration reduction unit includes a mass member coupled to the vibration reduction unit.

In this case, a transformer may be provided in which the mass member includes a mass hollow that has a cross-section corresponding to a cross-section of the noise-generating unit and is formed through it to be coupled to the noise-generating unit so that the mass member and the noise-generating unit are coupled to be in contact with each other.

In addition, a transformer may be provided in which the vibration reduction unit includes a support part respectively coupled to the noise-generating unit and the mass member to receive the vibration and transmit it to the mass member.

In this case, a transformer may be provided in which the support part includes a support body extending along the outer circumference of the noise-generating unit to surround the noise-generating unit and coupled to be in contact with the noise-generating unit; and a support arm extending outward from the support body and coupled to the mass member.

In addition, a transformer may be provided in which the support arm includes a first support arm continuous with one end in the extension direction of the support body; and a second support arm continuous with the other end in the extension direction of the support body.

In this case, a transformer may be provided in which a plurality of support parts are provided, and the plurality of support parts are disposed to face each other with the noise-generating unit therebetween to be coupled to each other, and a plurality of mass members are provided, and one of the plurality of mass members is coupled to the first support arm, and the other of the plurality of mass members is coupled to the second support arm.

In addition, a transformer may be provided in which the support body extends to cover an outer side of the noise-generating unit along the outer circumferential direction thereof so that each end in the extension direction of the support body is positioned adjacent to each other, and the support arm includes a first support arm continuous with one end in the extension direction of the support body; and a second support arm continuous with the other end in the extension direction of the support body, and positioned adjacent to the first support arm.

In this case, a transformer may be provided in which the support part includes a support body through which the noise-generating unit penetrates and is coupled; and a coupling groove formed in the support body and coupled to the mass member.

In addition, a transformer may be provided in which the support part and the mass member are positioned to be spaced apart from each other, and the vibration reduction unit includes a mass arm configured to extend between the support part and the mass member, with each end in the extension direction of the mass arm being coupled to the support part and the mass member, respectively, to transmit the vibration transmitted to the support part to the mass member.

In this case, a transformer may be provided in which the transformer further includes an oil supply unit coupled to the exterior of the housing and configured to store oil, the noise-generating unit includes a piping member communicating with the oil supply unit and the housing, respectively, to form a flow path through which the stored oil flows into the space of the housing, and the vibration reduction unit at least partially surrounds the outer circumference of the piping member and is coupled to the piping member.

In addition, a transformer may be provided in which the noise-generating unit includes a ladder member coupled to the exterior of the housing and extending in the height direction of the housing, and the vibration reduction unit at least partially surrounds the outer circumference of the ladder member and is coupled to the ladder member.

According to the above configuration, the vibration reduction unit and the transformer including the same according to an exemplary embodiment of the present disclosure can reduce vibration generated during operation or noise caused thereby.

The transformer includes a housing. A housing space is formed inside the housing to accommodate a power transmission unit energizably connected to an external power source and load: When the transformer is operated, the current applied to the power transmission unit from the power source may be transmitted to an external load through the transformation process. In this case, the iron core member provided in the power transmission unit is formed by stacking a plurality of iron plates, and as the transformer operates, vibration and noise occur due to shaking of the plurality of iron plates.

A vibration reduction unit is coupled to the exterior of the housing. The vibration reduction unit includes a mass part that may be vibrated at a predetermined natural frequency by vibration. When vibration occurs, the mass part also vibrates at a natural frequency that can offset the generated vibration.

As it is known, sound is a type of wavelength. Therefore, by adjusting the natural frequency at which the vibration reduction unit vibrates, the vibration generated by the transformer is offset, and the intensity of the vibration can be reduced.

Accordingly, vibration or noise generated by the operation of the transformer can be reduced.

In addition, according to the above configuration, the vibration reduction unit and the transformer including the same according to an exemplary embodiment of the present disclosure can reduce vibration or noise of the member where vibration or noise is concentrated during operation.

An oil supply unit is provided in the transformer. The oil supply unit may communicate with the housing to supply insulating oil to the housing space. The oil supply unit and the housing are connected to each other in a fluid communication manner by a piping member. In this case, the piping member is coupled to them respectively on the exterior of the housing and the oil supply unit.

Therefore, the piping member is exposed to the outside of the housing and oil supply unit, and vibration and noise are concentrated there by its shape.

Meanwhile, a ladder member may be provided in the housing. The ladder member functions as a passage for moving to the upper side of the housing for maintenance and the like. The generated vibration and the resulting noise are concentration on the ladder member due to its shape.

A vibration reduction unit is provided in the transformer. The vibration reduction unit is located outside the housing forming the outer shape of the transformer. The vibration reduction unit is configured to be coupled to the piping member or the ladder member to offset the vibration concentrated on the piping member or the ladder member.

Accordingly, vibration concentrated on the noise-generating unit, such as a piping member or a ladder member, can be offset, thereby reducing the intensity of vibration and the intensity of noise accordingly.

In addition, according to the above configuration, the vibration reduction unit and the transformer including the same according to an exemplary embodiment of the present disclosure can simply reduce vibration or the resulting noise.

The vibration reduction unit is coupled to the piping member or the ladder member disposed outside the housing. The vibration reduction unit can be directly or indirectly coupled to the piping member or the ladder member to offset the vibration applied to the pipe member or the ladder member.

That is, it is not required to change the structure of the housing or the power transmission unit accommodated in the housing in order to provide the vibration reduction unit. The vibration reduction unit can reduce generated vibration and the resulting noise just by being coupled to the piping member or the ladder member positioned outside the transformer.

Therefore, the generated vibration or the resulting noise can be simply reduced. Furthermore, even after the transformer is manufactured and installed, the vibration reduction unit can be additionally installed, thereby improving manufacturing and design convenience.

In addition, according to the above configuration, the vibration reduction unit and the transformer including the same according to an exemplary embodiment of the present disclosure can be provided in various structures to simply reduce vibration or the resulting noise.

As described above, the vibration reduction unit can be provided in various components in which vibration or noise is concentrated, for example, a piping member or a ladder member. The vibration reduction unit is configured to be coupled and resonated with the piping member or the ladder member to offset the transmitted vibration.

That is, the vibration reduction unit may be coupled to various components provided in the transformer to offset the generated vibration. Accordingly, vibration transmitted to various components and noise thereby can be reduced.

In addition, according to the above configuration, the vibration reduction unit and the transformer including the same according to an exemplary embodiment of the present disclosure can be changed in its design in various forms.

In an embodiment, the vibration reduction unit may include a mass member to be directly coupled to the piping member or the ladder member.

In another embodiment, the vibration reduction unit may include a support part coupled to the piping member or the ladder member and a mass arm coupled to the support part. In the above embodiment, the mass member is coupled to the mass arm, so that the vibration reduction unit is formed in the form of a cantilever.

In yet another embodiment, the vibration reduction unit may include a support body surrounding the piping member or the ladder member and a coupling groove formed therein. In the above embodiment, the mass member may be inserted into the coupling groove to be coupled to the piping member or the ladder member.

Therefore, the vibration reduction unit may be designed and changed in various forms depending on the installation environment. Accordingly, design freedom and product applicability can be improved.

In addition, according to the above configuration, the vibration reduction unit and the transformer including the same according to an exemplary embodiment of the present disclosure can reduce various vibrations or the resulting noise.

In an embodiment, the mass member provided in each vibration reduction unit may be formed of different masses. As the mass of the mass member is changed, the natural frequency of the vibration reduction unit is changed so that the frequency of the offsettable vibration can also be adjusted.

In another embodiment, the length of the mass arm provided in the vibration reduction unit may be variously formed. As the length of the mass arm is changed, the natural frequency of the vibration reduction unit is changed so that the frequency of the offsettable vibration can also be adjusted.

In another embodiment, a plurality of mass members may be formed to have different masses. Accordingly, a single vibration reduction unit can offset vibrations of various frequencies.

Accordingly, the natural frequency may be easily adjusted by adjusting the mass or length of the components of the vibration reduction unit. Accordingly, the frequency of vibration that the vibration reduction unit may reduce can be diversified.

Advantageous effects of the present disclosure are not limited to the above-described effects, and should be understood to include all effects that can be inferred from the configuration of the disclosure described in the detailed description or claims of the present disclosure.

### BRIEF DESCRIPTION OF THE DRAWINGS

FIG. 1 is a perspective view illustrating a transformer according to an exemplary embodiment of the present disclosure.

FIGS. 2 to 3 are perspective views illustrating a state in which a heat dissipation unit is removed from the transformer of FIG. 1.

FIG. 4 is an A-A cross-sectional perspective view illustrating a power transmission unit provided inside the transformer of FIG. 1.

FIG. 5 is a partially enlarged perspective view illustrating part B of the transformer of FIG. 2.

FIG. 6 is a partially enlarged perspective view illustrating part C of the transformer of FIG. 2.

FIG. 7 is a partially enlarged perspective view illustrating part C of the transformer of FIG. 2.

FIG. 8 is a partially enlarged perspective view illustrating part E of the transformer of FIG. 2.

FIG. 9 is a perspective view illustrating a vibration reduction unit according to an exemplary embodiment of the present disclosure.

FIG. 10 is an exploded perspective view illustrating the vibration reduction unit of FIG. 9.

FIG. 11 is a cross-sectional view illustrating the vibration reduction unit of FIG. 9.

FIG. 12 is a perspective view (a) and a partially enlarged perspective view (b) illustrating another embodiment of the vibration reduction unit of FIG. 9.

FIG. 13 is a cross-sectional view illustrating the vibration reduction unit according to the embodiment of FIG. 12.

FIG. 14 is a perspective view illustrating another embodiment of the vibration reduction unit of FIG. 9.

FIG. 15 is a cross-sectional view illustrating the vibration reduction unit according to the embodiment of FIG. 14.

FIG. 16 is a conceptual diagram illustrating an application example of the vibration reduction unit of FIGS. 12 to 15.

FIG. 17 is a perspective view illustrating another embodiment of the vibration reduction unit of FIG. 9.

FIG. 18 is a perspective view illustrating a transformer to which a vibration reduction unit is applied according to another embodiment of the present disclosure.

FIG. 19 is a perspective view illustrating a vibration reduction unit provided in the transformer of FIG. 18.

FIG. 20 is an F-F cross-sectional perspective view illustrating the vibration reduction unit of FIG. 19.

FIG. 21 is an F-F cross-sectional view illustrating the vibration reduction unit of FIG. 19.

FIG. 22 is a G-G cross-sectional view illustrating the vibration reduction unit of FIG. 19.

FIG. 23 is a front view illustrating another embodiment of the vibration reduction unit of FIG. 19.

### DETAILED DESCRIPTION

Hereinafter, exemplary embodiments of the present disclosure will be described in detail so that those of ordinary skill in the art can readily implement the present disclosure with reference to the accompanying drawings. The present disclosure may be embodied in many different forms and is not limited to the embodiments set forth herein. In the drawings, parts unrelated to the description are omitted for clarity of description of the present disclosure, and throughout the specification, same or similar reference numerals denote same elements.

Terms and words used in the present specification and claims should not be construed as limited to their usual or dictionary definition. They should be interpreted as meaning and concepts consistent with the technical idea of the present disclosure, based on the principle that inventors may appropriately define the terms and concepts to describe their own disclosure in the best way.

Accordingly, the embodiments described in the present specification and the configurations shown in the drawings correspond to preferred embodiments of the present disclosure, and do not represent all the technical idea of the present disclosure, so the configurations may have various examples of equivalent and modification that can replace them at the time of filing the present disclosure.

In the following description, in order to clarify the features of the present disclosure, descriptions of some components may be omitted.

### 1. Term Definition

The term “communication” used in the following description means that one or more members are connected to each other so as to be in fluid communication. In an embodiment, the communication may be formed by a member such as a conduit, a pipe, a tubing, or the like. In the following description, communication may be used in the same sense as one or more members are being “fluidly connected” to each other.

The term “electrical conduction or electrically conducted or energization” used in the following description means that one or more members are connected to each other so as to transmit an electric current or an electrical signal. In an embodiment, the electrical conduction may be formed in a wired form by a conducting wire member or the like or in a wireless form such as Bluetooth, Wi-Fi, RFID, or the like. In an embodiment, the electrical conduction may include the meaning of “electrical communication.”

The term “fluid” used in the following description refers to any form of material that flows by external force and whose shape or volume can be changed. In an embodiment, the fluid may be a liquid such as water or a gas such as air.

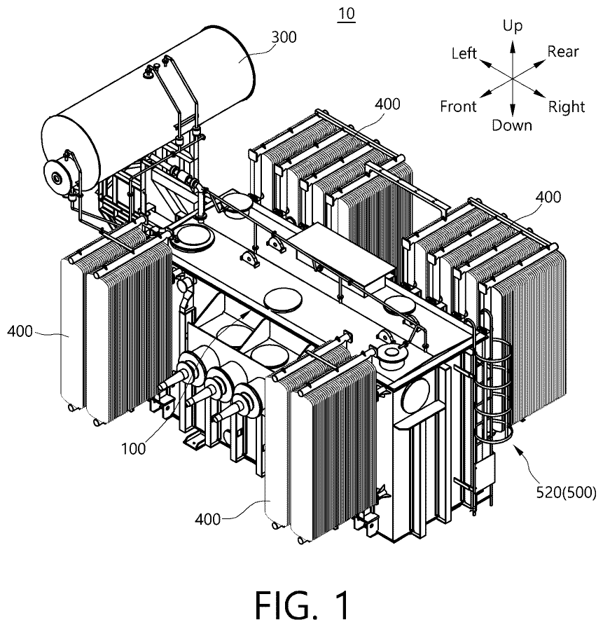

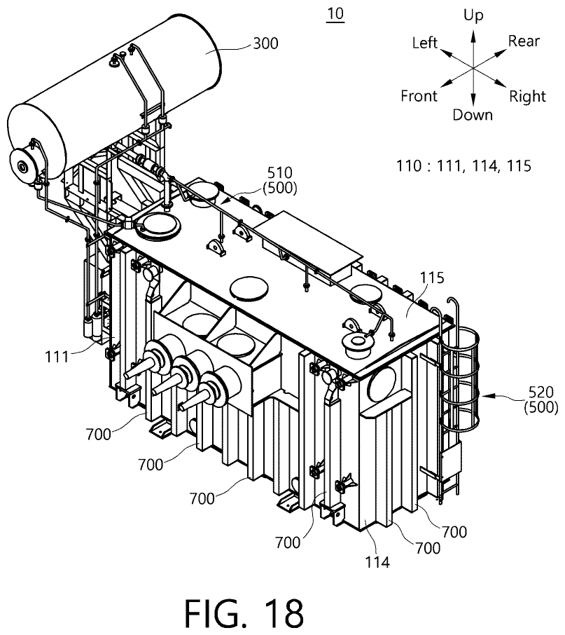

The terms “above or upper side”, “below or lower side”, “left side”, “right side”, “front side”, and “rear side” used in the following description will be understood with reference to the coordinate system shown in FIGS. 1 and 18.

### 2. Description of a Vibration Reduction Unit 600 and a Transformer 10 Including the Same According to an Exemplary Embodiment of the Present Disclosure

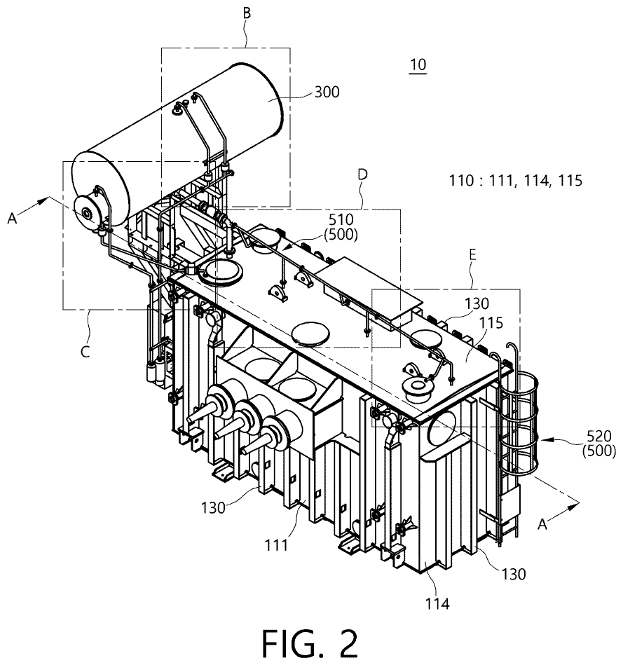

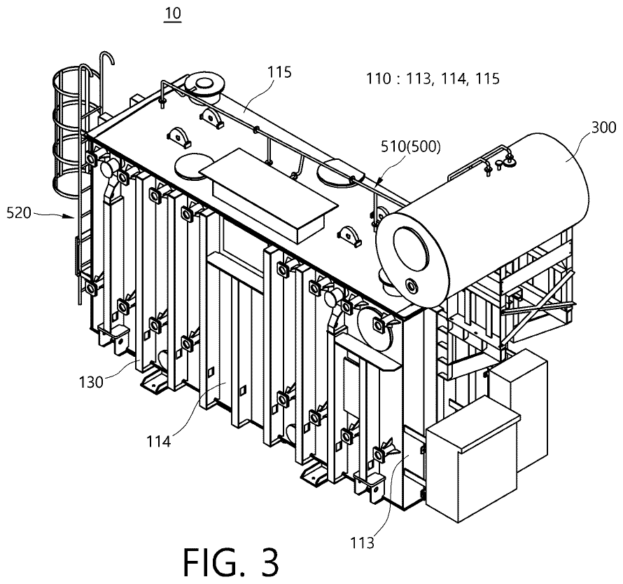

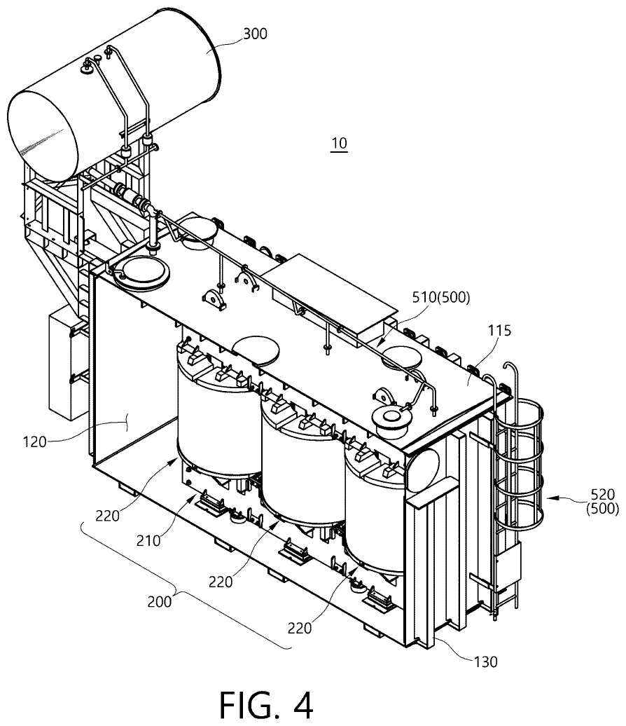

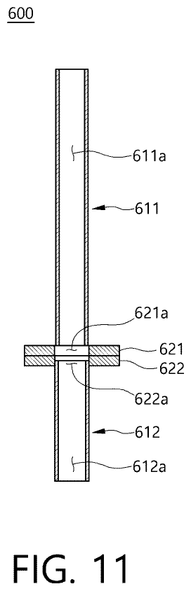

Referring to FIGS. 1 to 17, each configuration of the vibration reduction unit 600 and the transformer 10 including the same according to an exemplary embodiment of the present disclosure is illustrated.

The vibration reduction unit 600 according to the present embodiment may be coupled to a component that generates noise by resonating with vibration generated when the transformer 10 operates, among the components of the transformer 10. The vibration reduction unit 600 may be configured to reduce noise generated from the component by offsetting vibration generated from the component.

As will be described later, the component may be arranged to protrude from the transformer 10 or may be coupled to the transformer 10 at a single point. That is, the component may resonate more easily with vibration generated by the transformer 10 compared to other components and may cause noise.

Accordingly, the vibration reduction unit 600 according to the present embodiment may be configured to be coupled to the component to offset vibration generated from the component. Accordingly, noise generated from the component may also be reduced.

The vibration reduction unit 600 to be described below may be optionally provided along with the vibration reduction unit 700 according to another embodiment to be described below. In other words, the transformer 10 according to an exemplary embodiment of the present disclosure may be provided with at least one of the vibration reduction unit 600 according to the present embodiment and the vibration reduction unit 700 according to the other embodiment.

Accordingly, the vibration generated during the operation of the transformer 10 is effectively offset or reduced, and the noise generated by the vibration may also be reduced.

The transformer 10 according to an exemplary embodiment of the present disclosure is configured to reduce vibration or noise caused by magnetostriction generated in an iron core member 210 during operation. This may be achieved by the vibration reduction unit 600.

The transformer 10 is energizably connected to the outside. The transformer 10 may receive a current that is a voltage adjustment target. The transformer 10 may transmit a voltage-regulated current to the outside. In an embodiment, the current may be alternating current (AC).

Since the operating principle of the transformer 10 is a well-known technology, a detailed description thereof will be omitted.

Hereinafter, a configuration of the vibration reduction unit 600 and the transformer 10 including the same according to an embodiment of the present disclosure will be described in detail with reference to the accompanying drawings.

In the embodiments shown in FIGS. 1 to 8, the transformer 10 includes a housing 100, a power transmission unit 200, an oil supply unit 300, a heat dissipation unit 400, a noise-generating unit 500, and a vibration reduction unit 600.

The housing 100 forms the outer shape of the transformer 10. A space is formed inside the housing 100 to accommodate various components of the transformer 10. The space of the housing 100 may be electrically conducted with the outside to transmit a current that is an object of voltage transformation. In addition, the transformed current may be transferred back to the outside.

The housing 100 may have an arbitrary shape capable of forming the outer shape of the transformer 10 and mounting various components. In the illustrated embodiment, the housing 100 has a rectangular cross-section in which the extension length in the left-right direction is longer than the extension length in the front-rear direction and has a rectangular pillar shape extending in the up-down direction.

In the illustrated embodiment, the housing 100 includes a wall part 110, a housing space 120, and a reinforcing part 130.

The wall part 110 forms the outer circumference of the housing 100. The wall part 110 surrounds the space formed inside the housing 100, that is, the housing space 120, from the outside.

A plurality of wall parts 110 may be provided. The plurality of wall parts 110 may form the outer circumference of the housing 100 at different positions. In the illustrated embodiment, a pair of wall parts 110 spaced apart from each other in the up-down direction, another pair of wall parts 110 spaced apart from each other in the left-right direction, and a wall part 110 positioned on the rear side are provided. Each pair of wall parts 110 is arranged to face each other with the housing space 120 interposed therebetween.

The wall part 110 may have an arbitrary shape capable of forming the outer circumference of the housing 100 and surrounding the housing space 120. In the illustrated embodiment, the wall part 110 is provided in a rectangular plate shape having a rectangular cross-section and extending with a predetermined thickness.

The plurality of wall parts 110 may be continuous to form a predetermined angle with each other. In the illustrated embodiment, adjacent wall parts 110 among the plurality of wall parts 110 are continuously perpendicular to each other. The coupling method of the plurality of wall parts 110 may vary depending on the structure of the housing 100.

The plurality of wall parts 110 are disposed to surround the housing space 120 at a plurality of positions. In the illustrated embodiment, the plurality of wall parts 110 are disposed to surround the housing space 120 on the front side, the rear side, the upper side, the lower side, the left side, and the right side, respectively.

In the illustrated embodiment, the wall part 110 includes a first wall 111, a second wall 112, a third wall 113, a fourth wall 114, and a fifth wall 115.

The first wall 111 is provided as one of the wall parts 110. The first wall 111 surrounds the housing space 120 from one side. In the illustrated embodiment, the first wall 111 is arranged on the front side, surrounding the housing space 120 from the front side. The first wall 111 is arranged to face the second wall 112 with the housing space 120 interposed therebetween.

The second wall 112 is provided as another one of the wall parts 110. The second wall 112 surrounds the housing space 120 from the opposite side. In the illustrated embodiment, the second wall 112 is arranged on the rear side, surrounding the housing space 120 from the rear side. The second wall 112 is arranged to face the first wall 111 with the housing space 120 interposed therebetween.

The third wall 113 is provided as yet another one of the wall parts 110. The third wall 113 surrounds the housing space 120 from another opposite side. In the illustrated embodiment, the third wall 113 is arranged on the left side, surrounding the housing space 120 from the left side. The third wall 113 is arranged to face the fourth wall 114 with the housing space 120 interposed therebetween.

The fourth wall 114 is provided as still another one of the wall parts 110. The fourth wall 114 surrounds the housing space 120 from yet another opposite side. In the illustrated embodiment, the fourth wall 114 is arranged on the right side, surrounding the housing space 120 from the right side. The fourth wall 114 is arranged to face the third wall 113 with the housing space 120 interposed therebetween.

A plurality of reinforcing parts 130 are formed on one or more of the first wall 111, the second wall 112, the third wall 113, and the fourth wall 114. In the illustrated embodiment, the reinforcing parts 130 are formed on all of the first to fourth walls 111, 112, 113, and 114. The reinforcing part 130 is configured to extend in the up-down direction to reinforce the rigidity of the first to fourth walls 111, 112, 113, and 114.

The fifth wall 115 is provided as an additional one of the wall parts 110. The fifth wall 115 is arranged to cover the housing space 120. In the illustrated embodiment, the fifth wall 115 is arranged on the upper side, surrounding the housing space 120 from the upper side.

Although not shown, the wall part 110 may include an additional wall surrounding the housing space 120 from the lower side. The additional wall may be arranged on the lower side, surrounding the housing space 120 from the lower side. In the above embodiment, the additional wall is arranged to face the fifth wall 115 with the housing space 120 interposed therebetween.

The housing space 120 is a space formed inside the housing 100. The housing space 120 accommodates various components of the transformer 10. In an embodiment, the housing space 120 may accommodate the power transmission unit 200. The housing space 120 is a space formed by being surrounded by the plurality of wall parts 110.

The housing space 120 is electrically conducted with the outside. A current to be transformed may be transferred to a component accommodated in the housing space 120. In addition, the boosted or reduced current may be transmitted to the outside by the power transmission unit 200. To this end, a plurality of conducting wire members (not shown) extending from the outside may be partially accommodated in the housing space 120.

The housing space 120 communicates with the oil supply unit 300. Oil, such as insulating oil, accommodated in the oil supply unit 300 may be introduced into the housing space 120 and filled in the housing space 120. The insulating oil is configured to insulate the power transmission unit 200 accommodated in the housing space 120 from other components of the housing 100.

The reinforcing part 130 is coupled to the wall part 110 to reinforce the rigidity of the wall part 110. The reinforcing part 130 is formed to extend in one direction in which the wall part 110 extends, that is, in the up-down direction in the illustrated embodiment.

A plurality of reinforcing parts 130 may be provided. The plurality of reinforcing parts 130 may be disposed to be spaced apart from each other in a direction different from the direction in which the wall part 110 extends. In the embodiment shown in FIGS. 1 to 4, the reinforcing parts 130 are arranged to be spaced apart from each other in the front-rear direction.

The reinforcing part 130 may be formed at a plurality of positions. As described above, a plurality of wall parts 110 may be provided to surround the housing space 120 in various directions. Accordingly, the reinforcing part 130 may be formed for each of the plurality of wall parts 110. In the illustrated embodiment, the reinforcing parts 130 are formed on the first to fourth walls 111, 112, 113, and 114, respectively.

The reinforcing part 130 may have an arbitrary shape coupled to the wall part 110 to reinforce the rigidity of the wall part 110. In the illustrated embodiment, the reinforcing part 130 is provided in the form of a column extending in the up-down direction and having a predetermined thickness toward the outside. In addition, in the illustrated embodiment, the reinforcing part 130 is provided in the form of an I-beam.

The power transmission unit 200 boosts or reduces a current transmitted from the outside. Accordingly, it may be said that the power transmission unit 200 substantially performs the function of the transformer 10.

The power transmission unit 200 is accommodated in the housing space 120. Since the housing space 120 is defined by being surrounded by a plurality of wall parts 110, the power transmission unit 200 accommodated in the housing space 120 is also surrounded by a plurality of wall parts 110 and is not arbitrarily exposed to the outside.

Therefore, the power transmission unit 200 is not damaged by the environment outside the transformer 10. In addition, operators staying near the transformer 10 are physically separated from the power transmission unit 200, so that safety accidents caused by electric currents applied to the power transmission unit 200 can be prevented.

The power transmission unit 200 is electrically conducted with the outside. The electrical conduction may be formed by a conducting wire member (not shown) or the like conducting the housing space 120 to the outside. A process in which the introduced current is boosted or reduced by the power transmission unit 200 is a well-known technology, and thus a detailed description thereof will be omitted.

The power transmission unit 200 accommodated in the housing space 120 is surrounded by oil (i.e., insulating oil) filled in the housing space 120. Accordingly, an electrical insulation state between the other components of the housing 100 and the power transmission unit 200 may be maintained.

In the illustrated embodiment, the power transmission unit 200 includes an iron core member 210 and a winding member 220.

The iron core member 210 forms the structure of the power transmission unit 200. A plurality of winding members 220 that are electrically conducted with the outside are wound around the iron core member 210. When a current is applied to any one or more winding members 220 among the plurality of winding members 220, a magnetic flux is generated in the iron core member 210. The generated magnetic flux generates an induced electromotive force in the other one or more winding members 220 among the plurality of winding members 220.

The iron core member 210 may be formed by stacking a plurality of plates. In an embodiment, the iron core member 210 is formed by stacking a plurality of plates having a thickness in the front-rear direction.

The plurality of plates constituting the iron core member 210 may be formed of any material capable of forming a magnetic flux by a current applied to the winding member 220. In an embodiment, the plate may be formed of a wrought iron material.

The iron core member 210 may be formed in an arbitrary shape capable of forming a magnetic flux by being wound by a plurality of winding members 220.

The winding member 220 is wound around the iron core member 210. The current conducted to the winding member 220 generates a magnetic flux in the iron core member 210, and the current may be boosted or reduced by the induced electromotive force caused by the generated magnetic flux and transmitted to the outside.

The winding member 220 is electrically conducted with the outside. A current to be boosted or reduced may be transferred to the winding member 220. The boosted or reduced current may be transferred to the outside.

The winding member 220 is wound around the iron core member 210. Specifically, the winding member 220 is wound around portions of the iron core member 210 that extend in the height direction, that is, in the up-down direction in the illustrated embodiment.

The winding member 220 is accommodated in the iron core member 210. Specifically, the winding member 220 is accommodated in a space surrounded between the portions extending in the height direction.

A plurality of winding members 220 may be provided. The plurality of winding members 220 may be spaced apart from each other and wound around the iron core member 210 at different positions.

In the illustrated embodiment, three winding members 220 are provided and are spaced apart from each other. The plurality of winding members 220 are not in contact with each other.

Among the plurality of winding members 220, any one winding member 220 may be electrically conducted with the outside to receive a current to be boosted or reduced. Among the plurality of winding members 220, other winding member 220 may be electrically conducted with the outside to transmit a boosted or reduced current to the outside.

A current induced by a current conducted to the one winding member 220 may be conducted to the remaining one winding member 220 among the plurality of winding members 220. In addition, the remaining one winding member 220 may induce a current to the other winding member 220 through the induced current.

The winding member 220 may be provided in an arbitrary form capable of being wound around the iron core member 210 to generate an induced electromotive force. In the illustrated embodiment, the winding member 220 has a cylindrical shape that has a circular cross-section with a hollow formed inside and extends in the up-down direction.

The winding member 220 may be provided in an arbitrary form in which a current induced by a current conducted to any one winding member 220 may be energized. In an embodiment, the winding member 220 may be provided as a coil.

The oil supply unit 300 stores oil supplied to the housing space 120. The oil supply unit 300 may communicate with the housing space 120 and transfer the stored oil to the housing space 120.

The oil supply unit 300 is coupled to the housing 100. The oil supply unit 300 is arranged to be exposed outside the housing 100. In the illustrated embodiment, the oil supply unit 300 is located on the upper left side of the housing 100.

The oil supply unit 300 may have an arbitrary shape capable of storing oil and supplying the stored oil to the housing space 120. In the illustrated embodiment, the oil supply unit 300 has a cylindrical shape having a circular cross-section, and a length in the front-rear direction.

A piping member 510 is coupled to the oil supply unit 300. The oil supply unit 300 may communicate with the housing space 120 through the piping member 510. In this case, the piping member 510 may be coupled to the outer surface of the oil supply unit 300 and generate noise due to vibration.

Accordingly, the transformer 10 according to an exemplary embodiment of the present disclosure includes the vibration reduction unit 600 coupled to the piping member 510, thereby reducing noise generated from the piping member 510. This will be described later in detail.

The heat dissipation unit 400 is configured to dissipate heat generated as the transformer 10 operates to the outside. The heat dissipation unit 400 may be coupled to the wall part 110 of the housing 100 to receive heat and emit the received heat to the outside. Accordingly, the power transmission unit 200 and oil accommodated in the housing space 120 are cooled, thereby preventing the occurrence of overheating.

The heat dissipation unit 400 may be provided in any form capable of cooling the power transmission unit 200 and oil by receiving heat generated from the housing space 120 and discharging the heat to the outside. In an embodiment, the heat dissipation unit 400 may be provided as a radiator.

A plurality of heat dissipation units 400 may be provided. The plurality of heat dissipation units 400 may be respectively coupled to different parts of the housing 100 to dissipate heat generated in the housing space 120 to the outside. In the illustrated embodiment, four heat dissipation units 400 are provided, with a pair of heat dissipation units 400 located on the left and right sides of the first wall 111, and the other pair of heat dissipation units 400 located on the left and right sides of the second wall 112, respectively.

The noise-generating unit 500 is positioned on the exterior of the transformer 10 and collectively refers to a structure that resonates with vibration generated by the power transmission unit 200, thereby generating noise. The noise-generating unit 500 may be coupled to components exposed to the outside of the transformer 10, such as the housing 100 or the oil supply unit 300.

The noise-generating unit 500 may include a pipe-shaped or rod-shaped structure. That is, the noise-generating unit 500 is formed to have an arbitrary shape in which the diameter of the cross-section or the length of the outer diameter is shorter than the extension length. Therefore, the noise-generating unit 500 may receive vibration generated from the power transmission unit 200 and resonate with the vibration, thereby generating strong noise.

In the illustrated embodiment, the noise-generating unit 500 includes a piping member 510 and a ladder member 520.

The piping member 510 forms a flow path through which oil flows. The piping member 510 communicates with the housing space 120 and the oil supply unit 300, respectively. The oil accommodated in the oil supply unit 300 may flow into the housing space 120 through the piping member 510. As described above, the oil is filled between the power transmission unit 200 and the wall part 110 accommodated in the housing space 120.

The piping member 510 is coupled to the wall part 110. In the illustrated embodiment, the piping member 510 is coupled to the fifth wall 115 located at an upper side at a plurality of points. The piping member 510 extends between the plurality of the points. In the illustrated embodiment, the piping member 510 extends in the left-right direction but is branched in the up-down direction at a plurality of points and coupled to the fifth wall 115.

The piping member 510 is coupled to the oil supply unit 300. In the illustrated embodiment, the piping member 510 is coupled to the upper side of the outer circumference of the oil supply unit 300 and extends along the outer circumference of the oil supply unit 300. The piping member 510 coupled to the oil supply unit 300 is coupled to a piping member 510 coupled to the fifth wall 115 to communicate with each other.

The piping member 510 may be provided with a vibration reduction unit 600 to be described later. The vibration reduction unit 600 is configured to reduce the resonance of the piping member 510 and the noise generated thereby.

The ladder member 520 provides a path for moving to the upper structure of the housing 100 for maintenance and the like. The ladder member 520 is coupled to the wall part 110 of the housing 100, that is, the fourth wall 114 in the illustrated embodiment. The ladder member 520 is formed to extend in the height direction of the housing 100, that is, in the up-down direction in the illustrated embodiment.

The ladder member 520 may be provided in an arbitrary form that allows an operator to elevate in the height direction of the housing 100. In the illustrated embodiment, the ladder member 520 is provided as a ladder extending in the up-down direction.

The ladder member 520 may also be provided with a vibration reduction unit 600 to be described later. Resonance generated in the ladder member 520 and the resulting noise may be reduced by the vibration reduction unit 600.

Referring back to FIGS. 1 to 11, the transformer 10 according to the illustrated embodiment includes a vibration reduction unit 600.

The vibration reduction unit 600 according to the present embodiment is configured to be coupled to the noise-generating unit 500 to reduce resonance and the resulting noise. By the vibration reduction unit 600, vibration or noise generated from the piping member 510 or the ladder member 520 exposed to the outside may be reduced.

The vibration reduction unit 600 is coupled to the noise-generating unit 500. The vibration reduction unit 600 may be configured to reduce noise by offsetting vibration generated from the noise-generating unit 500.

The vibration reduction unit 600 may be provided in an arbitrary form capable of reducing vibration and noise by being coupled to the noise-generating unit 500. In the illustrated embodiment, the vibration reduction unit 600 may be provided as a mass and may function as a damper.

The vibration reduction unit 600 may be coupled to an arbitrary position of the noise-generating unit 500. A plurality of vibration reduction units 600 may be provided, and may be coupled to the noise-generating unit 500 at a plurality of points, respectively.

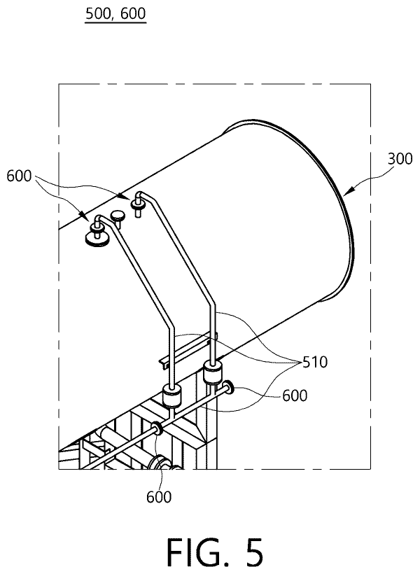

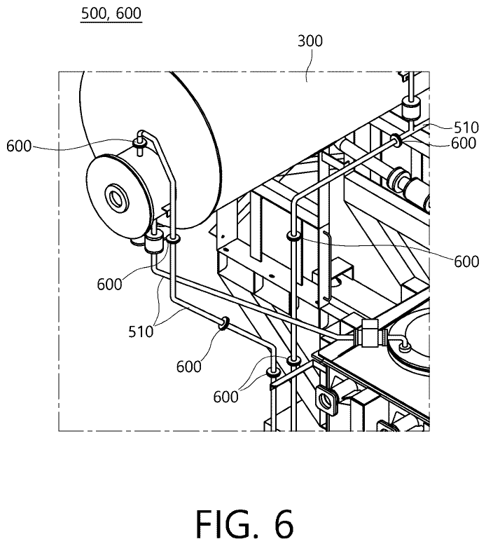

In the embodiments shown in FIGS. 5 to 6, the vibration reduction unit 600 may be coupled to a piping member 510 coupled to the oil supply unit 300 and be configured to reduce vibration and noise generated in the oil supply unit 300 and the piping member 510.

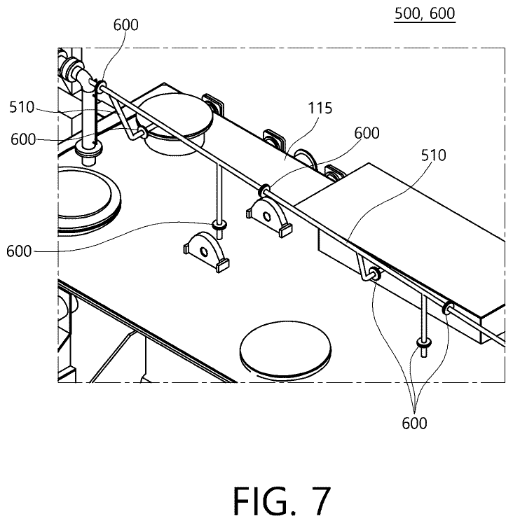

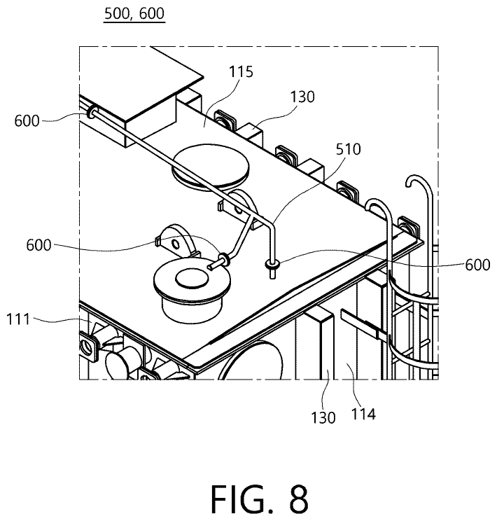

In the embodiments shown in FIGS. 7 to 8, the vibration reduction unit 600 may be coupled to a piping member 510 coupled to the housing 100 and be configured to reduce vibration and noise generated in the housing 100 and the piping member 510.

Although not shown, the vibration reduction unit 600 may also be provided in the ladder member 520 and be configured to reduce vibration and noise generated in the housing 100 and the ladder member 520.

Therefore, the plurality of vibration reduction units 600 may be coupled to the noise-generating unit 500 at various positions to reduce the generated vibration and noise. The plurality of vibration reduction units 600 respectively arranged at each point may offset vibrations or noises generated from the housing 100, the power transmission unit 200, or the oil supply unit 300 and traveling in various directions.

Accordingly, vibration and noise generated at each point are minimized, thereby improving the environment in which the transformer 10 is located, and preventing damage to the transformer 10 due to vibration.

In this case, the vibration reduction unit 600 may be arranged in an offset manner adjacent to the housing 100 or the oil supply unit 300 among various parts of the noise-generating unit 500. Accordingly, vibration or noise before or immediately after the vibration generated in the housing 100 or the oil supply unit 300 is transmitted to the noise-generating unit 500 may be reduced.

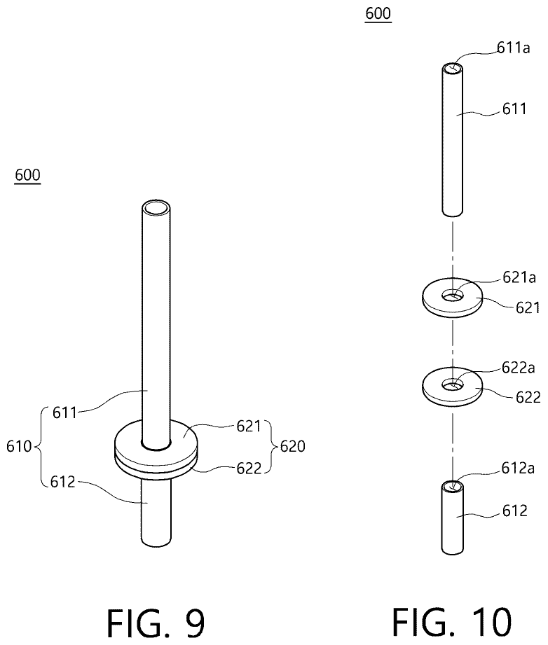

Referring to FIGS. 9 to 11, an example of the vibration reduction unit 600 according to an exemplary embodiment of the present disclosure is illustrated.

In the illustrated embodiment, the vibration reduction unit 600 includes a rod part 610 and a mass part 620.

The rod part 610 is a portion to which the mass part 620 is coupled among portions of the piping member 510 or the ladder member 520 constituting the noise-generating unit 500. That is, the rod part 610 is defined as a part of the components of the noise-generating unit 500 that is located adjacent to the mass part 620. Therefore, it will be understood in the following description that the rod part 610 and the noise-generating unit 500 may be used to indicate the same component.

Therefore, the rod part 610 is formed to have a pipe shape or a rod shape similar to the piping member 510 or the ladder member 520. In other words, the rod part 610 is formed to have an extension length longer than the diameter of its cross-section. In the illustrated embodiment, the rod part 610 is formed in a pipe shape having a circular cross-section, extending in one direction and having a hollow formed therein.

The rod part 610 may be divided into a plurality of portions. The plurality of portions may be respectively coupled to the mass part 620 at different positions. In the illustrated embodiment, the rod part 610 includes a first rod 611 positioned on the upper side and a second rod 612 positioned on the lower side.

In the illustrated embodiment, the first rod 611 and the second rod 612 extend in the up-down direction. One end in the extension direction of the first rod 611, that is, the lower end in the illustrated embodiment, is coupled to the mass part 620. One end in the extension direction of the second rod 612, that is, the upper end in the illustrated embodiment, is coupled to the mass part 620.

The one end of the first rod 611 and the one end of the second rod 612 are coupled to each other by mass hollows 621a and 622a formed inside the mass part 620 to communicate with each other.

To this end, a first rod hollow 611a is formed through the first rod 611 in the extension direction thereof. In addition, a second rod hollow 612a is formed through the second rod 612 in the extension direction thereof. The first rod hollow 611a and the second rod hollow 612a may communicate with each other to form a closed space through which oil may flow.

The mass part 620 is configured to reduce vibration or noise generated from the rod part 610. That is, the mass part 620 functions as a damper.

The mass part 620 is coupled to the rod part 610. In an embodiment, the mass part 620 may be in contact with the rod part 610 and may be configured to receive generated vibration or noise and offset the received vibration or noise.

As the name indicates, the mass part 620 may be formed to have a predetermined mass. In this case, the mass of the mass part 620 may be determined by the following Mathematical Equation 1 related to the natural frequency.

$$f = \frac{1}{2 π} \sqrt{\frac{k}{m}} \qquad [ Mathematical Equation 1 ]$$

In Mathematical Equation 1, f is a natural frequency, m is a mass of the mass part 620, and k may be defined as a variable related to the spring constant, i.e., rigidity, of the mass part 620. Therefore, it will be understood that m may be determined by the density or volume of the mass part 620, and k may be determined by the material or the like of the mass part 620.

In an embodiment, the natural frequency of the mass part 620 may be determined as a multiple of 120 Hz. This is because the vibration generated by the transformer 10 generally has a frequency corresponding to a multiple of 120 Hz.

The mass part 620 may have an arbitrary shape capable of being coupled to the rod part 610 and offsetting and reducing transmitted vibration or noise. In the illustrated embodiment, the mass part 620 is provided as a donut-shaped plate with a circular plate shape but a hollow penetrating in the thickness direction therein.

The mass part 620 may be composed of a plurality of portions. Some of the plurality of portions may be coupled to the first rod 611, and another some of the plurality of portions may be coupled to the second rod 612.

In the illustrated embodiment, the mass part 620 includes a first mass part 621 positioned on the upper side and coupled to the first rod 611 and a second mass part 622 positioned on the lower side and coupled to the second rod 612. The first mass part 621 and the second mass part 622 may be disposed to be in contact with each other.

A first mass hollow 621a is formed through the inside of the first mass part 621, so that the one end, that is, the lower end, of the first rod 611 may pass therethrough. The inner circumference of the first mass part 621 may be in contact with the outer circumference of the inserted first rod 611.

A second mass hollow 622a is formed through the inside of the second mass part 622, so that the one end, that is, the upper end, of the second rod 612 may pass therethrough. The inner circumference of the second mass part 622 may be in contact with the outer circumference of the inserted second rod 612.

The first mass hollow 621a and the second mass hollow 622a may be formed to correspond to the shapes of the first rod 611 and the second rod 612. In the illustrated embodiment, the first mass hollow 621 a and the second mass hollow 622a are formed as a disk-shaped space having a circular cross-section and a thickness in the up-down direction.

In this case, the first mass part 621 and the second mass part 622 may be formed to have various masses according to the frequency of vibration to be reduced.

The vibration reduction unit 600 according to the present embodiment may be applied in the step of manufacturing and installing the noise-generating unit 500. Alternatively, the vibration reduction unit 600 may be provided in the form of being coupled to the previously installed noise-generating unit 500. In this case, the mass members 621 and 622 are provided as a plurality of parts, and when the rod part 610 is inserted into the mass hollows 621a and 622a, it may be configured to be coupled to each other.

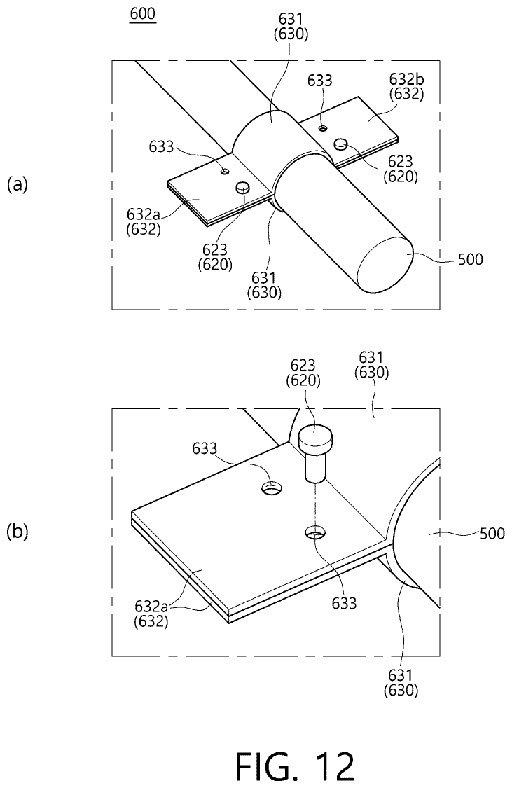

Referring to FIGS. 12 to 16, a modified example of the vibration reduction unit 600 according to the present embodiment is illustrated.

In this modified example, the vibration reduction unit 600 further includes a support part 630 fixed to the noise-generating unit 500 and a mass arm 640 coupled to the support part 630. Accordingly, in the present modified example, the mass part 620 is indirectly coupled to the noise-generating unit 500 through the support part 630 and the mass arm 640.

The support part 630 is a portion where the vibration reduction unit 600 is directly coupled to the noise-generating unit 500. The support part 630 may be formed to at least partially surround the outer circumference of the noise-generating unit 500. The support part 630 is directly coupled to the noise-generating unit 500.

In addition, at least a portion of the support part 630 may protrude radially to be coupled to the mass arm 640. The mass part 620 may be coupled to the support part 630 by the mass arm 640.

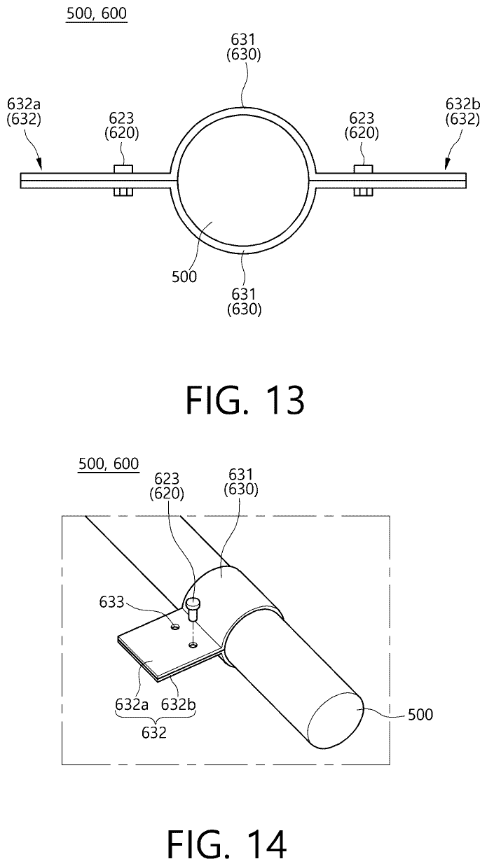

In the embodiments illustrated in FIGS. 12 to 13, the support part 630 includes a support body 631, a support arm 632, and a coupling groove 633.

The support body 631 is a portion where the support part 630 is coupled to the noise-generating unit 500. The support body 631 is formed to correspond to the shape of the outer circumference of the noise-generating unit 500 and extends along the outer circumference of the noise-generating unit 500. The support body 631 may be disposed to surround the outer circumference of the noise-generating unit 500.

In the illustrated embodiment, the support body 631 is formed in an arc shape having a central angle of about 180°. In the above embodiment, the curvature of the support body 631 may be formed to correspond to the curvature of the outer circumference of the noise-generating unit 500.

In the above embodiment, a pair of support parts 630 may be provided. The pair of support parts 630 may be disposed to face each other with the noise-generating unit 500 interposed therebetween, and may be disposed to surround the noise-generating unit 500 at different positions, respectively. In this case, the inner surfaces of the pair of support parts 630 may be in contact with the outer surface of the noise-generating unit 500, respectively.

The support body 631 is continuous with the support arm 632.

The support arm 632 is a portion where the support part 630 is coupled to the mass arm 640. The support arm 632 extends outward from each end of the support body 631. The support arm 632 may extend at a predetermined angle with the outer circumference of the noise-generating unit 500 or one end of the support body 631. In an embodiment, the predetermined angle may be a right angle.

The support arm 632 may have any shape that may be coupled to the support body 631 and the mass arm 640. In the illustrated embodiment, the support arm 632 is provided in a plate shape having a rectangular cross-section and a thickness in a direction in which the pair of support parts 630 are spaced apart, that is, in the up-down direction.

A plurality of support arms 632 may be provided. The plurality of support arms 632 may extend outward from each end of the support body 631. In the illustrated embodiment, the support arm 632 includes a first support arm 632a extending from the left end of the support body 631, and a second support arm 632b extending from the right end of the support body 631.

In an embodiment in which a plurality of support parts 630 are provided, the support arms 632 provided on each of the pair of support parts 630 may be disposed to overlap each other.

A coupling groove 633 is formed inside the support arm 632.

The coupling groove 633 is a space in which a coupling member (not shown) for coupling a pair of support parts 630 is coupled. The coupling groove 633 is formed inside the support arm 632 to penetrate in the thickness direction thereof, that is, in the up-down direction in the illustrated embodiment. The coupling member (not shown) may be coupled through the coupling groove 633.

In an embodiment, a third mass member 623 may be coupled to the coupling groove 633. As illustrated in FIGS. 12 to 13, the third mass member 623 is provided in the form of a screw member and may be inserted into or coupled through the coupling groove 633. In the above embodiment, the third mass member 623 may offset and reduce vibration or noise and at the same time may couple the support arms 632 provided on the pair of support parts 630.

That is, the coupling member (not shown) itself coupled to the coupling groove 633 may be provided as a third mass member 623.

A plurality of coupling grooves 633 may be provided. The plurality of coupling grooves 633 may be spaced apart from each other and coupled to the coupling member (not shown) or the third mass member 623, respectively. In the illustrated embodiment, the coupling grooves 633 are provided in a pair and are spaced apart from each other in the extension direction of the noise-generating unit 500.

Accordingly, the plurality of support parts 630 may be stably coupled to prevent arbitrary fluctuation or random separation from the noise-generating unit 500. In addition, the generated vibration or noise may be reduced by being offset by the third mass member 623 coupled to the coupling groove 633.

In an embodiment in which a plurality of third mass members 623 are provided, the masses of the plurality of third mass members 623 may be configured to be different from each other. Accordingly, the vibration reduction unit 600 may be configured to reduce by offsetting vibration or noise of various frequencies.

In an embodiment in which a plurality of support arms 632 are provided, the coupling groove 633 may be formed in the plurality of support arms 632, respectively. In the illustrated embodiment, a pair of coupling grooves 633 are formed on the first support arm 632a on the left side and the second support arm 632b on the right side, respectively.

Each pair of coupling grooves 633 formed in the first support arm 632a and the second support arm 632b may be disposed to match each other and communicate with each other when a pair of support parts 630 are coupled to the noise-generating unit 500. Accordingly, the coupling member (not shown) or the third mass member 623 may penetrate the coupling groove 633 formed in the pair of support parts 630, respectively.

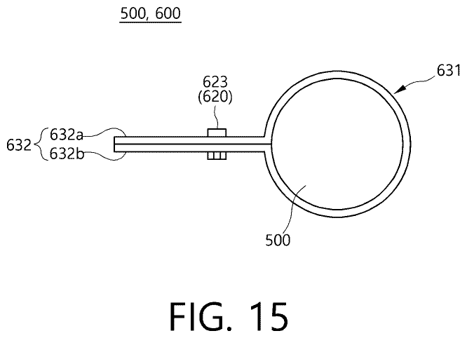

Referring to FIGS. 14 to 15, another modified example of the vibration reduction unit 600 according to the present embodiment is illustrated.

In this modified example, a single support part 630 may be provided so that the single support part 630 may be configured to surround the noise-generating unit 500. Accordingly, the support body 631 may extend to be longer than the extension length of the support body 631 according to the above-described embodiment.

In the illustrated embodiment, the support body 631 is formed to have a circular cross-section. In the above embodiment, the support body 631 may be formed to have an inner circumference having a length corresponding to the length of the noise-generating unit 500 in the outer circumferential direction.

In addition, as a single support part 630 is provided and a single support body 631 is configured to surround the outer circumference of the noise-generating unit 500, a pair of support arms 632a and 632b may be arranged to be biased in the same direction. In the illustrated embodiment, the first support arm 632a is located on the upper left side with respect to the noise-generating unit 500, and the second support arm 632b is located on the lower left side.

In the above embodiment, the first support arm 632a and the second support arm 632b may be disposed to overlap each other. Accordingly, the coupling grooves 633 respectively formed in the first support arm 632a and the second support arm 632b are arranged to overlap each other in the thickness direction, that is, in the up-down direction in the illustrated embodiment, to communicate with each other.

As the first support arm 632a and the second support arm 632b overlap, the third mass member 623 may be coupled to the coupling grooves 633 that are disposed to overlap each other. In an embodiment, the third mass member 623 may be provided in the form of a coupling member such as a screw member. In the above embodiment, the third mass member 623 may be configured to reduce vibration or noise while coupling the first support arm 632a and the second support arm 632b.

As described above, in an embodiment in which a plurality of third mass members 623 are provided, the masses of the plurality of third mass members 623 may be configured to be different from each other. Accordingly, the vibration reduction unit 600 may be configured to reduce by offsetting vibration or noise of various frequencies.

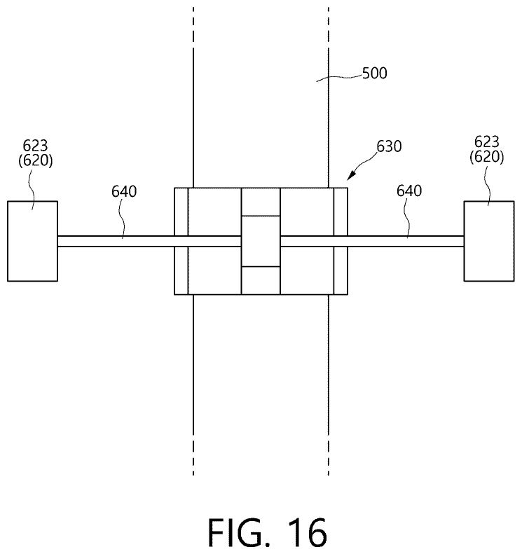

Referring to FIG. 16, yet another modified example of the vibration reduction unit 600 according to an exemplary embodiment of the present disclosure is illustrated.

In this modified example, the vibration reduction unit 600 further includes a support part 630 fixed to the noise-generating unit 500 and a mass arm 640 coupled to the support part 630. Accordingly, in the present modified example, the mass part 620 is in indirect contact with the noise-generating unit 500 through the support part 630 and the mass arm 640.

The mass arm 640 is coupled to the support arm 632 and the mass part 620, respectively. The mass arm 640 receives vibrations transmitted to the rod part 610 and the support part 630 and transmits the vibrations to the mass part 620.

The mass arm 640 may change the resonance frequency f by affecting the spring constant k as shown in [Mathematical Equation 2] below.

$$δ = \frac{{PL}^{3}}{3 EI} , k = \frac{F}{δ} = \frac{3 EI}{{PL}^{3}} \qquad [ Mathematical Equation 2 ]$$

In this case, δ is the displacement of the mass part 620 coupled to the mass arm 640, E is the elastic modulus of the mass arm 640, I is the moment of inertia of the mass arm 640, P is the mass of the mass part 620, and L is the length of the mass arm 640.

That is, when the mass part 620 is coupled to the rod part 610 by the support part 630 and the mass arm 640, various factors such as the length, elastic modulus, and moment of inertia of the mass arm 640 may be adjusted as well as the mass of the mass part 620. Accordingly, the natural frequency magnitude of the vibration reduction unit 600 can also be adjusted to various values, allowing the vibration and the resulting noise generated by the transformer 10 to be more effectively reduced.

In the present embodiment, as shown in FIG. 16, the mass part 620 may be provided as a third mass member 623. The third mass member 623 may be provided in an arbitrary form capable of being coupled to the mass arm 640 and affecting the natural frequency of the vibration reduction unit 600. That is, in the present embodiment, the mass part 620 may have an arbitrary shape capable of applying a mass.

In the present embodiment, a plurality of third mass members 623 coupled to each mass arm 640 may be formed to have different masses. As described above, the plurality of third mass members 623 may be configured to reduce vibrations of different frequencies or noise generated thereby.

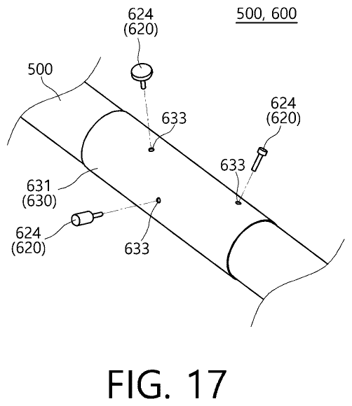

Referring to FIG. 17, a modified example of the vibration reduction unit 600 according to the present embodiment is illustrated.

In this modification, the support part 630 includes only the support body 631 and the coupling groove 633 formed in the support body 631 without the support arm 632. In addition, the mass part 620 includes a fourth mass member 624 inserted into and coupled to the coupling groove 633.

In the present embodiment, the support body 631 is formed to surround the outer circumference of the noise-generating unit 500. That is, the support body 631 has an annular (ring-shaped) cross-section and extends in the extension direction of the noise-generating unit 500. A hollow penetrating in the extension direction of the support body 631 may be formed inside the support body 631, so that the noise-generating unit 500 may be coupled therethrough.

A coupling groove 633 is formed inside the support body 631. The coupling groove 633 may be formed through or recessed so that the fourth mass member 624 may be inserted and coupled thereto. A plurality of coupling grooves 633 may be provided and may be disposed at different positions of the support body 631, respectively.

The fourth mass member 624 may be formed in any form that may be inserted into and coupled to the coupling groove 633. In the illustrated embodiment, the fourth mass member 624 is formed in a bolt shape, so that its head part is located radially outside and its body part is located radially inside.

In an embodiment, the fourth mass member 624 may be detachably coupled to the coupling groove 633. In the above embodiment, the mass or shape of the fourth mass member 624 is variously configured, and may be coupled to or separated from the support part 630 depending on the frequency of the generated vibration.

In an embodiment, a plurality of fourth mass members 624 may be provided. The plurality of fourth mass members 624 may be coupled to a plurality of coupling grooves 633, respectively. In this case, the mass or shape of the plurality of fourth mass members 624 may be different. Accordingly, the plurality of fourth mass members 624 may be configured to offset vibrations of different frequencies.

The vibration reduction unit 600 according to the present embodiment described above is directly or indirectly coupled to the noise-generating unit 500 exposed to the outside of the transformer 10. The vibration reduction unit 600 is configured to have a natural frequency corresponding to the frequency of the vibration transmitted to the noise-generating unit 500, so that the generated vibration may be offset. Accordingly, vibration or noise generated as the transformer 10 operates may be reduced.

Meanwhile, when a plurality of vibration reduction units 600 are provided, the frequency of vibration that may be offset by each vibration reduction unit 600 may be configured differently. Accordingly, vibrations of various frequencies may be offset, and thus generated vibrations or noise caused thereby may be reduced.

### 3. Description of a Vibration Reduction Unit 700 and a Transformer 10 Including the Same According to Another Exemplary Embodiment of the Present Disclosure

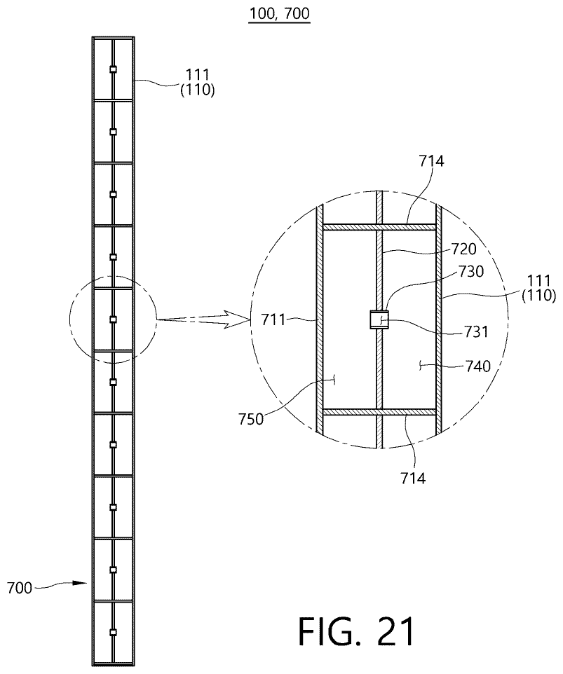

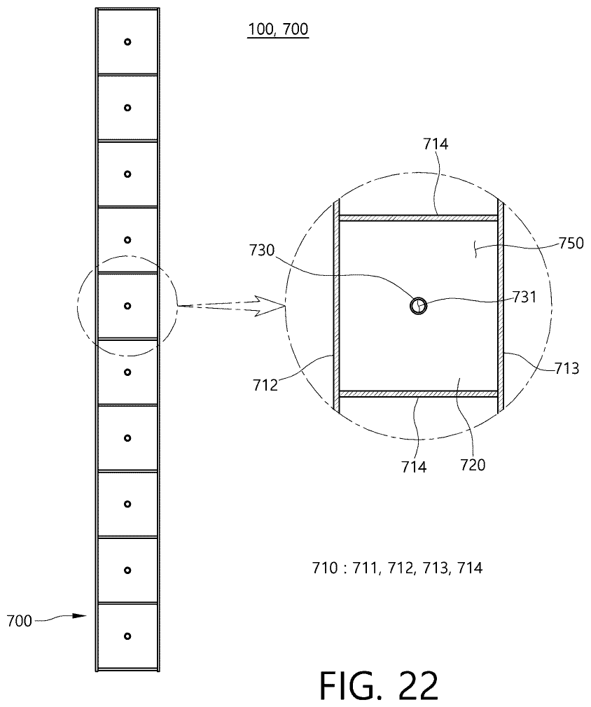

Referring to FIGS. 18 to 23, each configuration of the vibration reduction unit 700 and the transformer 10 including the same according to another exemplary embodiment of the present disclosure is illustrated.

The transformer 10 according to the present embodiment is different in that it includes a vibration reduction unit 700 according to another embodiment instead of the vibration reduction unit 600 according to the above-described embodiment. Accordingly, the description of the common components in the following description will be replaced with the description of the transformer 10 according to the above-described embodiment.

However, as described above, the transformer 10 according to an exemplary embodiment of the present disclosure may optionally include vibration reduction units 600 and 700 according to each embodiment. In an embodiment, the transformer 10 may be configured to include all vibration reduction units 600 and 700 according to each embodiment.

In the embodiment shown in FIG. 18, the transformer 10 includes a housing 100, an oil supply unit 300, a heat dissipation unit 400, a noise-generating unit 500, and a vibration reduction unit 700. In addition, although not shown, the power transmission unit 200 may be accommodated in the housing 100 in the same manner as in the above-described embodiment.

The housing 100, the power transmission unit 200, the oil supply unit 300, the heat dissipation unit 400, and the noise-generating unit 500 according to the present embodiment have the same structure and function as the housing 100, the power transmission unit 200, the oil supply unit 300, the heat dissipation unit 400, and the noise-generating unit 500 provided in the transformer 10 according to the above-described embodiment.

However, the transformer 10 according to the present embodiment differs in that the vibration reduction unit 700 even serves as the reinforcing part 130.

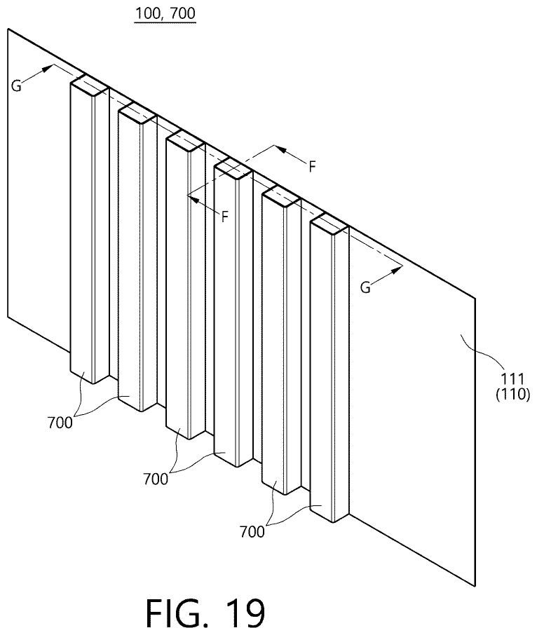

Hereinafter, the vibration reduction unit 700 according to another embodiment of the present disclosure will be described in detail with reference to FIGS. 19 to 22.

The vibration reduction unit 700 is coupled to the housing 100 and configured to reduce transmitted vibration or noise.

Specifically, the vibration reduction unit 700 is coupled to the wall part 110 of the housing 100, and configured to reduce vibration or noise generated by the power transmission unit 200 and transmitted to the housing 100.

The vibration reduction unit 700 is accommodated in the housing space 120 and coupled to the inner surface of the wall part 110. A plurality of vibration reduction units 700 may be provided on one or more of the first to fourth walls 111, 112, 113, and 114 surrounding the housing space 120. In addition, the vibration reduction unit 700 may also be provided on the lower wall, which is not shown.

The vibration reduction unit 700 is not in direct contact with the power transmission unit 200. That is, the vibration reduction unit 700 is configured to reduce vibration or noise transmitted through a fluid, for example, air or oil in the housing space 120 as a medium. In an embodiment, the vibration reduction unit 700 may reduce vibration or noise generated by using a resonance phenomenon. In the above embodiment, the vibration reduction unit 700 may be defined as a resonator.

A plurality of vibration reduction units 700 may be provided. The plurality of vibration reduction units 700 may be disposed to be stacked in the height direction of the housing 100, that is, in the up-down direction in the illustrated embodiment. The vibration reduction units 700 adjacent to each other may be in contact with each other.

That is, in the above embodiment, the vibration reduction unit 700 may be provided in a modular form and configured in various forms depending on the frequency of the vibration to be offset.

In the following description, a structure formed by stacking a plurality of vibration reduction units 700 in the height direction is defined as a group of vibration reduction units 700.

The group of vibration reduction units 700 provided on each of the first to fourth walls 111, 112, 113, and 114 may be plural.

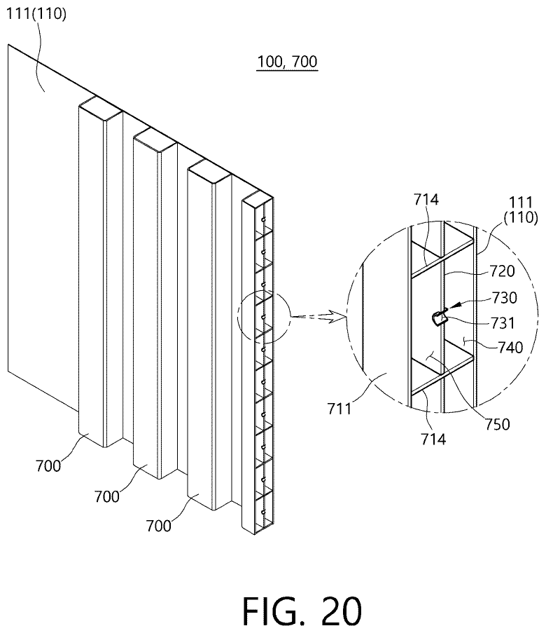

That is, as shown in FIGS. 19 to 20, a total of six groups of vibration reduction units 700 are disposed on the first wall 111 to be spaced apart from each other in the width direction of the first wall 111, that is, in the left-right direction in the illustrated embodiment. In the illustrated embodiment, it is assumed that the vibration reduction unit 700 is provided on the first wall 111, but it will be understood that the vibration reduction unit 700 is also provided on the second to fourth walls 112, 113, and 114. The number of groups of vibration reduction units 700 provided on the first to fourth walls 111, 112, 113, and 114 may be changed.

In addition, each vibration reduction unit 700 constituting a group may be formed to have a natural frequency of different magnitudes. This may be adjusted according to the position of a partition member 720, the shape of a pipe member 730, and the volume of a resonance space 750 to be described later.

Therefore, a group of vibration reduction units 700 may be configured to simultaneously offset vibrations of different frequencies.

In an embodiment, a plurality of vibration reduction units 700 may be detachably coupled to each other. The vibration reduction unit 700 of each group coupled to the wall part 110 may also be detachably coupled to the wall part 110. Accordingly, in response to the frequency of vibration generated by the transformer 10, the vibration reduction unit 700 may be provided in the transformer 10 in various forms.

The vibration reduction unit 700 may have an arbitrary shape capable of reducing noise generated by the transformer 10 by using a resonance phenomenon. In the illustrated embodiment, the vibration reduction unit 700 has a three-dimensional figure shape having a rectangular cross-section and a height in the front-rear direction.

By the above structure, a plurality of vibration reduction units 700 may be stacked in the height direction of the housing 100 to perform the role of the reinforcing part 130.

In the embodiments shown in FIGS. 20 to 22, the vibration reduction unit 700 includes a frame 710, a partition member 720, a pipe member 730, a transmission space 740, and a resonance space 750.

The frame 710 forms the outer shape of the vibration reduction unit 700. The frame 710 may be coupled to the wall part 110 to seal the transmission space 740 and the resonance space 750 formed therein.

In the illustrated embodiment, the frame 710 forms the front side, upper side, lower side, left side, and right side of the vibration reduction unit 700. The rear side of the frame 710 is formed to be open but is configured to be covered by the wall part 110.

A predetermined space is formed inside the frame 710. The space is divided into a plurality of spaces, that is, a transmission space 740 and a resonance space 750, by the partition member 720. The frame 710 is formed to at least partially surround the transmission space 740 and the resonance space 750.

In the illustrated embodiment, the frame 710 includes a first frame 711, a second frame 712, a third frame 713, and a fourth frame 714.

The first frame 711 forms one side of the frame 710, that is, the front side in the illustrated embodiment. The first frame 711 is positioned opposite to the wall part 110. Accordingly, it may be said that the first frame 711 forms one side opposite to the wall part 110 among each part of the frame 710.

The first frame 711 partially surrounds the resonance space 750. In the illustrated embodiment, the first frame 711 surrounds the front side of the resonance space 750.

The first frame 711 is continuous with the second to fourth frames 712, 713, and 714, respectively.

The second frame 712 forms another side of the frame 710, that is, the left side in the illustrated embodiment. The second frame 712 surrounds the transmission space 740 and the resonance space 750 on the said another side, i.e., the left side. The second frame 712 is disposed to face the third frame 713 with the transmission space 740 and the resonance space 750 interposed therebetween.

The third frame 713 forms yet another side of the frame 710, that is, the right side in the illustrated embodiment. The third frame 713 surrounds the transmission space 740 and the resonance space 750 on the said yet another side, i.e., the right side. The third frame 713 is disposed to face the second frame 712 with the transmission space 740 and the resonance space 750 interposed therebetween.

One end in the extension direction of the second and third frames 712 and 713, that is, the front side in the illustrated embodiment, is continuous with the first frame 711. The other end in the extension direction of the second and third frames 712 and 713, that is, the rear side in the illustrated embodiment, is continuous with the wall part 110.

The fourth frame 714 forms still yet another side of the frame 710, that is, the upper side and lower side in the illustrated embodiment. The fourth frame 714 surrounds the transmission space 740 and the resonance space 750 on the said still yet another side, i.e., the upper side and lower side. The fourth frame 714 is configured as a pair facing each other with the transmission space 740 and the resonance space 750 interposed therebetween.

The space formed inside the frame 710 is divided into the transmission space 740 and the resonance space 750 by the partition member 720.

The partition member 720 is located in a space formed inside the frame 710. The partition member 720 is formed in a shape corresponding to the cross-section of the space formed inside the frame 710. The partition member 720 divides the space into a plurality of spaces in a direction toward the outside of the transformer 10, that is, in the front-rear direction.

The partition member 720 may have a shape corresponding to the shape of the space formed inside the frame 710. Since the space is defined by being surrounded by the first to fourth frames 711, 712, 713, and 714, it may be said that the partition member 720 may be formed to correspond to the shapes of the first to fourth frames 711, 712, 713, and 714.

In the illustrated embodiment, the partition member 720 is formed in a rectangular plate shape having a rectangular cross-section and a thickness in the front-rear direction. It will be understood that the shape of the partition member 720 corresponds to the shape of the first frame 711.

A space formed on one side of each side of the partition member 720 toward the first frame 711, that is, on the front side in the illustrated embodiment, may be defined as a resonance space 750. A space formed on the other side of each side of the partition member 720 toward the wall part 110, that is, on the rear side in the illustrated embodiment, may be defined as a transmission space 740.

The partition member 720 divides the space formed inside the frame 710 into a transmission space 740 and a resonance space 750 but may block the communication between the transmission space 740 and the resonance space 750. Accordingly, communication between the transmission space 740 and the resonance space 750 is achieved by the pipe member 730 coupled to the partition member 720.

The partition member 720 may be disposed at an arbitrary position capable of dividing a space formed inside the frame 710 into a transmission space 740 and a resonance space 750. In this case, the distance between the partition member 720 and the first frame 711 or between the partition member 720 and the wall part 110 is adjusted, so that the volume of the transmission space 740 and the resonance space 750 may be adjusted.

By the above adjustment, the natural frequency of the vibration reduction unit 700 may be adjusted, which will be described in detail below.

The pipe member 730 is coupled to the partition member 720.

The pipe member 730 communicates the transmission space 740 and the resonance space 750 partitioned by the partition member 720. The pipe member 730 is coupled to the partition member 720. In an embodiment, the pipe member 730 may be coupled through the partition member 720.

The pipe member 730 extends between the transmission space 740 and the resonance space 750, that is, in the front-rear direction in the illustrated embodiment. One end of the pipe member 730 in the extension direction is positioned in the transmission space 740 and the other end is positioned in the resonance space 750.

The pipe member 730 may have an arbitrary shape capable of communicating the transmission space 740 with the resonance space 750. In the illustrated embodiment, the pipe member 730 includes a pipe hollow 731 formed through the inside thereof. That is, the pipe member 730 is provided as a circular pipe shape having a circular cross-section and extending in the front-rear direction.

The pipe member 730 may be coupled to the partition member 720 at an arbitrary position where the transmission space 740 and the resonance space 750 may communicate with each other. In the illustrated embodiment, the pipe member 730 is disposed to have the same center as the center of the cross-section of the partition member 720.

The pipe member 730 may extend by a predetermined length. In addition, the pipe hollow 731 formed inside the pipe member 730 may be formed to have a predetermined diameter. As will be described later, the extension length of the pipe member 730 and the diameter of the pipe hollow 731 may be used as factors that determine the natural frequency of the vibration reduction unit 700.

The transmission space 740 is a space that is biased toward the wall part 110 among a plurality of spaces partitioned by the partition member 720. In other words, the transmission space 740 may be defined as a space facing the wall part 110 among the plurality of partitioned spaces. The transmission space 740 primarily receives the vibration generated by the transformer 10 through the wall part 110.

The transmission space 740 is defined by being surrounded by the wall part 110, the frame 710, and the partition member 720. In the illustrated embodiment, the front side of the transmission space 740 is surrounded by the partition member 720, the left side by the second frame 712, the right side by the third frame 713, and the upper side and lower side by the fourth frame 714. In addition, the rear side of the transmission space 740 is surrounded by the wall part 110.

The transmission space 740 may be formed to have a predetermined volume. In this case, the volume of the transmission space 740 may be adjusted in a complementary manner to the volume of the resonance space 750. As described above, the adjustment may be achieved depending on the position of the partition member 720.

The pipe member 730 is partially accommodated in the transmission space 740. The transmission space 740 is communicated with the resonance space 750 by the pipe hollow 731. Vibration or noise transmitted to the transmission space 740 may be transmitted to the resonance space 750 through the pipe hollow 731.

The transmission space 740 is disposed to face the resonance space 750 with the partition member 720 interposed therebetween.

The resonance space 750 is a space where vibration or noise transmitted through the pipe member 730 is offset. Vibration or noise progressed to the resonance space 750 may be reduced by being offset by the above-described resonance phenomenon. Accordingly, the magnitude of vibration or noise emitted to the outside of the housing 100 coupled to the vibration reduction unit 700 may also be reduced.

The resonance space 750 is positioned to be biased toward the first frame 711 among a plurality of spaces partitioned by the partition member 720. In other words, the resonance space 750 may be defined as a space facing the first frame 711 among the plurality of partitioned spaces. The resonance space 750 receives vibrations that have passed through the transmission space 740 and the pipe hollow 731. The vibration transmitted to the resonance space 750 may be offset through a process to be described later.

The resonance space 750 is defined by being surrounded by the frame 710 and the partition member 720. In the illustrated embodiment, the front side of the resonance space 750 is surrounded by the first frame 711, the left side by the second frame 712, the right side by the third frame 713, and the upper side and lower side by the fourth frame 714. In addition, the rear side of the transmission space 740 is surrounded by the partition member 720.

The resonance space 750 may be formed to have a predetermined volume. In this case, the volume of the resonance space 750 may be adjusted in a complementary manner to the volume of the transmission space 740 depending on the position of the partition member 720.

The pipe member 730 is partially accommodated in the resonance space 750. The resonance space 750 is communicated with the transmission space 740 by the pipe hollow 731.

Meanwhile, the natural frequency according to the length of the pipe member 730, the diameter of the pipe hollow 731, and the volume of the resonance space 750 may be derived by the following [Mathematical Equation 3].

$$f = \frac{v}{2 π} \sqrt{\frac{A}{V L}} \qquad [ Mathematical Equation 3 ]$$

In the above [Mathematical Equation 3], f is the natural frequency, v is the velocity of vibration or noise, A is the cross-sectional area of the pipe hollow 731, V is the volume of the resonance space 750, and L is the length of the pipe member 730.

Therefore, the natural frequency of the vibration reduction unit 700 may be adjusted to various sizes depending on the structure of the pipe member 730 or the position of the partition member 720.

In an embodiment, the natural frequency of the vibration reduction unit 700 may be determined as a multiple of 120 Hz. This is because the vibration generated by the transformer 10 generally has a frequency corresponding to a multiple of 120 Hz.

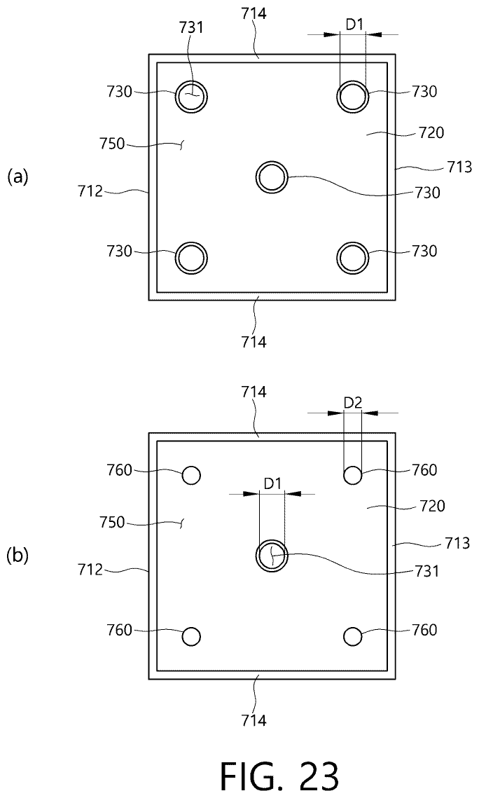

Referring to FIG. 23, a modified example of the vibration reduction unit 700 according to the present embodiment is illustrated.

Referring to (a) of FIG. 23, a plurality of pipe members 730 may be provided in the vibration reduction unit 700. The plurality of pipe members 730 may be spaced apart from each other and disposed at different positions of the partition member 720. Each of the plurality of pipe members 730 may be configured to communicate the transmission space 740 and the resonance space 750.

In the illustrated embodiment, a plurality of pipe hollows 731 are formed to have the same diameter, that is, the first diameter D1. Alternatively, the plurality of pipe hollows 731 may be formed to have different diameters.

In the present embodiment, the natural frequency by each pipe member 730 may be derived by the following [Mathematical Equation 4].

$${f}_{k} = \frac{v}{2 π} \sqrt{\frac{{A}_{k}}{{V}_{k} {L}_{k}}} \qquad [ Mathematical Equation 4 ]$$

In the above [Mathematical Equation 4], f is the natural frequency, v is the velocity of vibration or noise, A is the cross-sectional area of the pipe hollow 731, V is the volume of the resonance space 750, and L is the length of the pipe member 730. In addition, k is an index number indicating that it is any one of the n pipe members 730.

Therefore, in the illustrated embodiment, the natural frequency of the vibration reduction unit 700 may be variously adjusted by adjusting the number of pipe members 730 or the structure of each pipe member 730 or the like.

Referring to (b) of FIG. 23, a resonance through hole 760 is formed in the vibration reduction unit 700 in addition to the pipe member 730. The resonance through hole 760 may be formed through the partition member 720 to communicate the transmission space 740 with the resonance space 750.

A plurality of resonance through holes 760 may be formed. The plurality of resonance through holes 760 may be spaced apart from the pipe member 730 to be formed at different positions of the partition member 720. Diameters of the plurality of resonance through holes 760 may be independent of each other. In other words, the diameters of the plurality of resonance through holes 760 may be the same or different from each other.

In the illustrated embodiment, the resonance through hole 760 is formed to have the second diameter D2 which is less than or equal to the first diameter D1 which is the diameter of the pipe hollow 731. Alternatively, the second diameter D2 may be formed to be greater than or equal to the first diameter D1.

In the present embodiment, the natural frequency by the resonance through hole 760 may be derived by the following [Mathematical Equation 5].

$${f}_{k} = \frac{v}{2 π} \sqrt{\frac{{A}_{k}}{{V}_{k} {L}_{k}}} \qquad [ Mathematical Equation 5 ]$$

In the above [Mathematical Equation 5], f is the natural frequency, v is the velocity of vibration or noise, A is the cross-sectional area of the resonance through hole 760, V is the volume of the resonance space 750, and L is the thickness of the partition member 720. In addition, k is an index number indicating that it is any one of the n resonance through holes 760.

Therefore, in the illustrated embodiment, the natural frequency of the vibration reduction unit 700 may be variously adjusted by adjusting the number or structure of the resonance through holes 760 or the structure of the resonance through hole 760 and the pipe member 730 or the like.

The vibration reduction unit 700 according to the present embodiment described above may be provided in the wall part 110 to reduce vibration or noise transmitted to the outside of the transformer 10. The vibration reduction unit 700 is configured to have a natural frequency corresponding to the frequency of the vibration generated by the transformer 10 by adjusting its structure, so that the generated vibration may be offset. Accordingly, vibration or noise generated as the transformer 10 operates may be reduced.

In addition, the vibration reduction unit 700 is provided in a modular form, so that its natural frequency may be adjusted according to the frequency of the target vibration to be offset. Accordingly, vibration or noise of various frequencies may be reduced.

Although exemplary embodiments of the present disclosure have been described, the idea of the present disclosure is not limited to the embodiments set forth herein. Those of ordinary skill in the art who understand the idea of the present disclosure may easily propose other embodiments through supplement, change, removal, addition, etc. of elements within the same idea, but the embodiments will be also within the scope of the present disclosure.

| | |
|---|---|
| 10: transformer | 100: housing |
| 110: wall part | 111: first wall |
| 112: second wall | 113: third wall |
| 114: fourth wall | 115: fifth wall |
| 120: housing space | 130: reinforcing part |
| 200: power transmission unit | 210: iron core member |
| 220: winding member | 300: oil supply unit |
| 400: heat dissipation unit | 500: noise-generating unit |
| 510: piping member | 520: ladder member |
| 600: vibration reduction unit | 610: rod part |
| 611: first rod | 611a: first rod hollow |
| 612: second rod | 612a: second rod hollow |
| 620: mass part | 621: first mass member |
| 621a: first mass hollow | 622: second mass member |
| 622a: second mass hollow | 623: third mass member |
| 624: fourth mass member | 630: support part |
| 631: support body | 632: support arm |
| 632a: first support arm | 632b: second support arm |
| 633: coupling through-hole | 640: mass arm |
| 700: vibration reduction unit | 710: frame |
| 711: first frame | 712: second frame |
| 713: third frame | 714: fourth frame |
| 720: partition member | 730: pipe member |
| 731: pipe hollow | 740: transmission space |
| 750: resonance space | 760: resonance through hole |
| D1: first diameter | D2: second diameter |

1. A vibration reduction unit, comprising:
a rod part connected to the outside and extending in one direction; and
a mass part coupled to the rod part so as to reduce vibration transmitted to the rod part,
wherein the mass part comprises:
a mass member formed to have a predetermined mass; and
a mass hollow formed to penetrate the inside of the mass member and to which the rod part is coupled.

2. The vibration reduction unit of claim 1,
wherein the mass part comprises:
a first mass member positioned to be biased to one side; and
a second mass member positioned adjacent to the first mass member and positioned to be biased to the other side, and
wherein the rod part comprises:
a first rod penetrating a first mass hollow of the first mass member; and
a second rod penetrating a second mass hollow of the second mass member, coupled to and communicating with the first rod.

3. The vibration reduction unit of claim 1, wherein the mass member extends radially with respect to the coupled rod and is formed in a plate shape having a thickness in the one direction.

4. A transformer, comprising:
a housing with a space formed therein;
a power transmission unit accommodated in the space of the housing and energizably connected to an external power source and load;
a noise-generating unit coupled to the exterior of the housing, receiving vibration generated by the power transmission unit, and extending in one direction by a length longer than the diameter of its cross-section; and
a vibration reduction unit coupled to the noise-generating unit and configured to reduce the transmitted vibration,
wherein the vibration reduction unit comprises a mass member coupled to the vibration reduction unit.

5. The transformer of claim 4,
wherein the mass member comprises:
a mass hollow that has a cross-section corresponding to a cross-section of the noise-generating unit and is formed through it to be coupled to the noise-generating unit,
so that the mass member and the noise-generating unit are coupled to be in contact with each other.

6. The transformer of claim 4,
wherein the vibration reduction unit comprises:
a support part respectively coupled to the noise-generating unit and the mass member to receive the vibration and transmit it to the mass member.

7. The transformer of claim 6,
wherein the support part comprises:
a support body extending along the outer circumference of the noise-generating unit to surround the noise-generating unit and coupled to be in contact with the noise-generating unit; and
a support arm extending outward from the support body and coupled to the mass member.

8. The transformer of claim 7,
wherein the support arm comprises:
a first support arm continuous with one end in the extension direction of the support body; and
a second support arm continuous with the other end in the extension direction of the support body.

9. The transformer of claim 8,
wherein a plurality of support parts are provided, and the plurality of support parts are disposed to face each other with the noise-generating unit therebetween to be coupled to each other, and
wherein a plurality of mass members are provided, and one of the plurality of mass members is coupled to the first support arm, and the other of the plurality of mass members is coupled to the second support arm.

10. The transformer of claim 7,
wherein the support body extends to cover an outer side of the noise-generating unit along the outer circumferential direction thereof so that each end in the extension direction of the support body is positioned adjacent to each other, and
wherein the support arm comprises:
a first support arm continuous with one end in the extension direction of the support body; and
a second support arm continuous with the other end in the extension direction of the support body, and positioned adjacent to the first support arm.

11. The transformer of claim 6,
wherein the support part comprises:
a support body through which the noise-generating unit penetrates and is coupled; and
a coupling groove formed in the support body and coupled to the mass member.

12. The transformer of claim 6,
wherein the support part and the mass member are positioned to be spaced apart from each other, and
wherein the vibration reduction unit comprises:
a mass arm configured to extend between the support part and the mass member, with each end in the extension direction of the mass arm being coupled to the support part and the mass member, respectively, to transmit the vibration transmitted to the support part to the mass member.

13. The transformer of claim 4,
further comprising an oil supply unit coupled to the exterior of the housing and configured to store oil,
wherein the noise-generating unit comprises:
a piping member communicating with the oil supply unit and the housing, respectively, to form a flow path through which the stored oil flows into the space of the housing, and
wherein the vibration reduction unit at least partially surrounds the outer circumference of the piping member and is coupled to the piping member.

14. The transformer of claim 4,
wherein the noise-generating unit comprises:
a ladder member coupled to the exterior of the housing and extending in the height direction of the housing, and
wherein the vibration reduction unit at least partially surrounds the outer circumference of the ladder member and is coupled to the ladder member.
